(19) United States
(12) Patent Application Publication
(10) Pub. No.: US 2016/0216694 A1
(43) Pub. Date: Jul. 28, 2016

(54) COVER FOR SMART WATCH

(71) Applicant: WILLIAM C. KNEEBUSCH, VALLEY CITY, OH (US)

(72) Inventor: WILLIAM C. KNEEBUSCH, VALLEY CITY, OH (US)

(21) Appl. No.: 15/006,711

(22) Filed: Jan. 26, 2016

Related U.S. Application Data
(60) Provisional application No. 62/108,802, filed on Jan. 28, 2015.

(51) Int. Cl. G04B 37/00; G04B 37/14

(52) U.S. Cl. CPC G04B 37/0008; G04B 37/1486

(57) ABSTRACT

A smart watch is herein disclosed, wherein the smart watch includes a watch face, a watch band, the watch band attached to the watch face, and a cover, the cover movably attached to the watch face, wherein the cover has at least one transparent area, wherein the at least one transparent area is above at least part of the watch face.

### FIELD

This application claims priority to a provisional patent application, entitled Cover For Smart Watch, having Serial No. 62/108,802, filed Jan. 28, 2015. The present teaching generally relates to methods and apparatuses for watches, and more particularly, to attaching a cover to a smart watch.

### BACKGROUND

### Description of the Related Art

Currently, individuals must choose between wearing a mechanical watch or wearing a smart watch.

### SUMMARY

In one example, a cover is connected to a smart watch.

Another example provides a way to create a decorative and more visually appealing smart watch. Additionally this covered style design provides protection for the smart watch screen and case beneath the cover. Other benefits and advantages will become apparent to those skilled in the art to which it pertains upon reading and understanding of the following detailed specification.

### DEFINITIONS

Smart watch—a mobile device with a touchscreen display, designed to be worn on the wrist, or to operate as a pocket watch.

Watch—a small timepiece designed to be worn or carried.

### BRIEF DESCRIPTION OF THE DRAWINGS

Example arrangements are described hereinafter with reference to the accompanying drawings.

FIG. 1A shows a front view of a smart watch with the cover closed;

FIG. 1B shows a front view of a round smart watch with the cover closed;

FIG. 2A shows a perspective view of the smart watch with the cover open and two with the cover closed; and,

FIG. 2B shows a perspective view of the round smart watch with the cover open and one with the cover closed.

### DETAILED DESCRIPTION

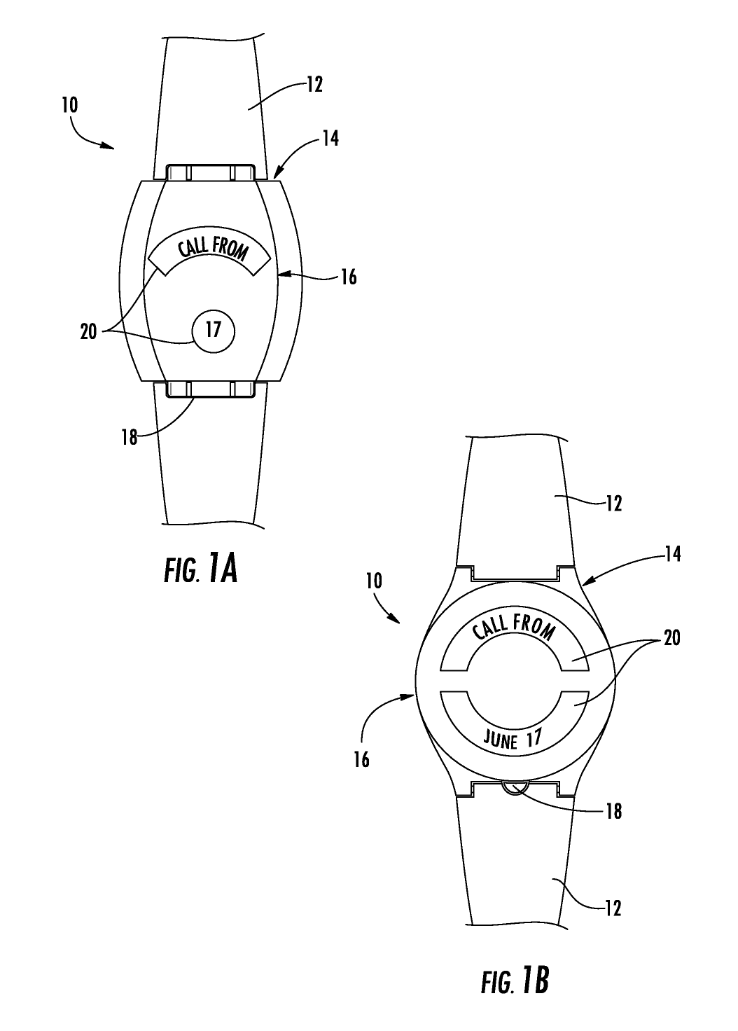

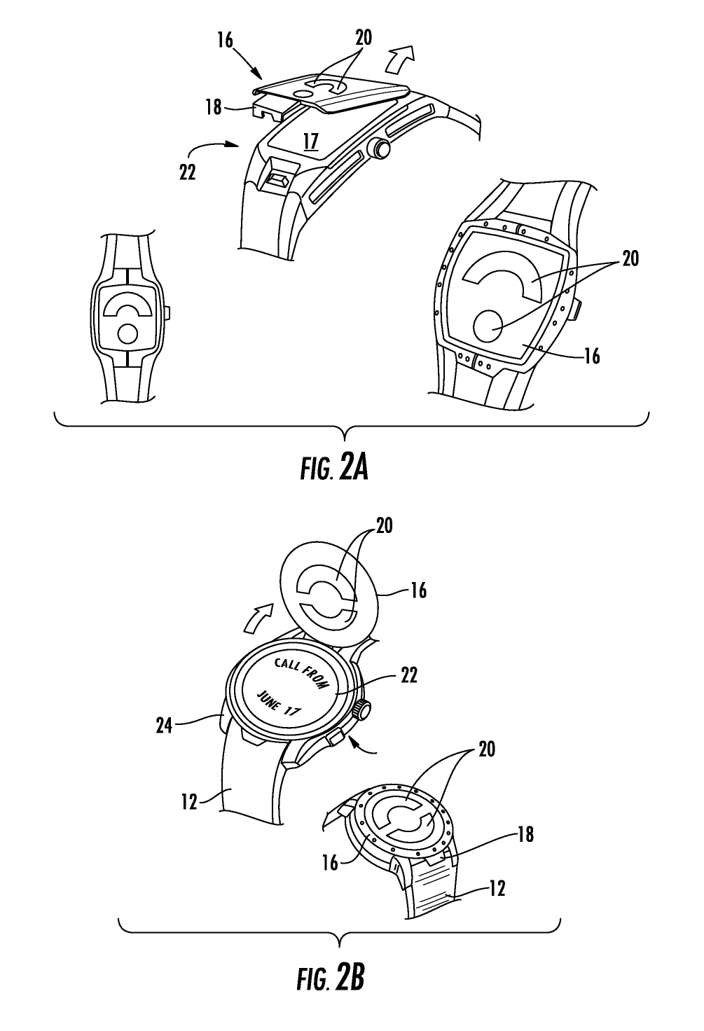

In reference to the FIGS. 1-2B, a design for a smart watch 10 is shown, where a hinged cover 16 and/or other attachment method is attached to a base which incorporates the smart watch 10. The watch 10 includes a band 12, a hinge 14, a cover 16, a clasp 18, opening(s) 20, watch face 22, and band attachment 24.

The cover 16 can be flipped up to view the smart watch face 22 below. The unique aspect of this design incorporates opening(s) 20 in a variety of configurations, which can be used to display certain data from the smart watch 10 below, without lifting the cover 16 to see the entire smart watch face 22. A software application can be created to utilize these openings 20 for information display, decorative/design purposes, entertainment, etc. or whatever the program is written to do. The present teaching creates a decorative and more visually appealing smart watch 10. Additionally, this covered style design provides protection for the smart watch face 22 beneath the cover 16.

With continuing reference to FIGS. 1-2B, it also to be understood that any means of connecting the cover 16 to the smart watch 10 can be used, and any configuration of openings 20 can be used. The attachment of the cover 16 to the watch face 22 is not limited to a hinge 14 and/or a clasp 18.

With continuing reference to FIGS. 1-2B, the band 12 is connected to the watch 10 by the band attachment 24. In this example, the watch 10 has a band attachment on both sides, so that the band 12 can be attached to watch 10. The cover 16 is attached to the watch face 22 by the hinge 14 on one side and the clasp 18 on the other side. The clasp 18 is engageably connected to the watch face 22, such that the cover 16 can be easily lifted up. The hinge 14 allows the cover 16 to move away from the watch face 22, as shown in FIG. 2A. The cover 16 can also be closed by pushing down on the cover 16, until the clasp 18 reattaches to the watch face 22. The opening(s) 20 in the cover 16 allow the user to read portions of the watch face 22 without lifting the cover 16. The opening(s) 20 can be positioned in the cover 16, so that the relevant information desired from the watch face 22 can be seen with the cover 16 closed.

The embodiments have been described, hereinabove. It will be apparent to those skilled in the art that the above methods and apparatuses may incorporate changes and modifications without departing from the general scope of the present teaching. It is intended to include all such modifications and alterations insofar as they come within the scope of the appended claims or the equivalents thereof.

Further examples consistent with the present teachings are set out in the following numbered clauses.

### Clauses

Clause 1—A smart watch including a watch face, a watch band, the watch band attached to the watch face, and a cover, the cover movably attached to the watch face, wherein the cover has at least one transparent area, wherein the at least one transparent area is above at least part of the watch face.

Clause 2—The smart watch of clause 1, wherein information displayed on the watch face aligns with the at least one transparent area on the cover.

Clause 3—The smart watch of clauses 1 or 2, wherein the cover is attached to the watch face by a hinge.

Clause 4—The smart watch of clauses 1-3, further comprising a clasp, wherein the clasp attaches to the watch face.

Clause 5—The smart watch of clauses 1-4, wherein the at least one transparent area is at least one opening in the cover.

Clause 6—The smart watch of clauses 1-5, wherein the at least one opening is at least two openings, wherein the display on the watch face aligns with the at least two openings.

Clause 7—A method for using a smart watch, the method including the steps of providing a smart watch having a watch face, a watch band, the watch band attached to the watch face, and a cover, the cover movably attached to the watch face, wherein the cover has at least one transparent area, wherein the at least one transparent area is above at least part of the watch face and programming the smart watch to display information aligned with the at least one transparent area.

Clause 8—The method of clause 7, wherein the cover is attached to the watch face by a hinge.

Clause 9—The method of clauses 7 or 8, wherein the smart watch further comprises a clasp, wherein the clasp attaches to the watch face.

Clause 10—The method of clauses 7-9, wherein the at least one transparent area is at least one opening in the cover.

Clause 11—The method of clauses 7-10, wherein the at least one opening is at least two openings, wherein the display on the watch face aligns with the at least two openings.

Having thus described the present teachings, it is now claimed:

1. A smart watch comprising:
a watch face;
a watch band, the watch band attached to the watch face; and,
a cover, the cover movably attached to the watch face, wherein the cover has at least one transparent area, wherein the at least one transparent area is above at least part of the watch face.

2. The smart watch of claim 1, wherein information displayed on the watch face aligns with the at least one transparent area on the cover.

3. The smart watch of claim 2, wherein the cover is attached to the watch face by a hinge.

4. The smart watch of claim 3, further comprising a clasp, wherein the clasp attaches to the watch face.

5. The smart watch of claim 4, wherein the at least one transparent area is at least one opening in the cover.

6. The smart watch of claim 5, wherein the at least one opening is at least two openings, wherein the display on the watch face aligns with the at least two openings.

7. A method for using a smart watch, the method comprising the steps of:
providing a smart watch having a watch face, a watch band, the watch band attached to the watch face, and a cover, the cover movably attached to the watch face, wherein the cover has at least one transparent area, wherein the at least one transparent area is above at least part of the watch face; and,
programming the smart watch to display information aligned with the at least one transparent area.

8. The method of claim 7, wherein the cover is attached to the watch face by a hinge.

9. The method of claim 8, wherein the smart watch further comprises a clasp, wherein the clasp attaches to the watch face.

10. The method of claim 9, wherein the at least one transparent area is at least one opening in the cover.

11. The method of claim 10, wherein the at least one opening is at least two openings, wherein the display on the watch face aligns with the at least two openings.
